(19) United States
(12) Patent Application Publication
(10) Pub. No.: US 2012/0168047 A1
(43) Pub. Date: Jul. 5, 2012

(54) CLAMSHELL DOOR HANDLE GRASPER

(76) Inventor: ROGER D. WILSON, BOISE, ID (US)

(21) Appl. No.: 13/177,550

(22) Filed: Jul. 6, 2011

Related U.S. Application Data
(60) Provisional application No. 61/361,742, filed on Jul. 6, 2010.
(60) Provisional application No. 61/425,727, filed on Dec. 21, 2010.
(60) Provisional application No. 61/434,021, filed on Jan. 19, 2011.
(60) Provisional application No. 61/453,812, filed on Mar. 17, 2011.

(51) Int. Cl. A45C 1/06; B25J 15/00; B25J 1/00

(52) U.S. Cl. 150/132; 294/106

(57) ABSTRACT

This invention is a firm bodied, clamshell-like device which is adapted to be easily opened to allow a user to conveniently grasp a door handle. Preferably, the clamshell has a hinge, or an easily repeatably foldable section, at or near its proximal end. Extending distally from the hinge section are generally planar both top and bottom plates. The plates may be relatively flat or curved. An easily operated lock/unlock latch may be located in the hinge. Alternately, a latch may be provided on the distal end of either the top or bottom plates, or along a side of either or both.

This application claims priority of Provisional Patent Application Ser. No. 61/361,742, filed Jul. 6, 2010, Provisional Patent Application Ser. No. 61/425,727, filed Dec. 21, 2010, Provisional Patent Application Ser. No. 61/434,021, filed Jan. 19, 2011, and Provisional Patent Application Ser. No. 61/453,812, filed Mar. 17, 2011, the entire disclosures of all of which are incorporated herein by this reference.

### BACKGROUND OF THE INVENTION

1. Field of the Invention

This invention relates generally to hygienic devices, and more particularly to a firm-bodied, clamshell-like device for grasping a door handle in a sanitary manner or for grasping other items or members.

2. Related Art

U.S. Pat. No. 2,695,999 (Arnold) discloses a hand shield of rubber or leather wherein the fingers of a wearer are disposed in a pocket or set of pockets.

U.S. Pat. No. 5,987,645 (Teaster) discloses a hand shield of absorbent material or plastic sheet with a pocket for the hand of a wearer.

U.S. Pat. No. 6,912,728 (Panella) discloses a flexible sheet barrier for protecting a user's hand while grasping a doorknob. Preferably, the Panella sheet is stored folded in a dispenser container, and is adapted to be disposed of after each use.

Still, there is a need for a portable germ or bacteria blocking device which does not contribute to a solid waste disposal problem. Also, there is still a need for such a device which may be re-used. Also, there is still a need for such a device which may be conveniently sanitized for re-use. This invention addresses these needs.

### SUMMARY OF THE INVENTION

This invention is a firm bodied, clamshell-like device, also called “grasping device” herein, which is adapted to be easily opened to allow a user to conveniently grasp a door handle and/or another item or object. Preferably, the device allows said grasping in a hygienic manner, so that bacterial or other microbes or pathogens are not transferred to the user's hand or fingers. The device may also be useful for other reasons, such as preventing fingerprints on the item/object and/or for protecting the hand or fingers from damage from the item/object. Preferably, the clamshell has a hinge, or an easily repeatably-foldable section, at or near its proximal end. Extending distally from the hinge section are generally planar both top and bottom plates. One or both plates may be relatively flat or may be curved.

An easily operated lock/unlock latch may be located in the hinge. Alternately, a latch may be provided on the distal end of either the top or bottom plates, or along a side of either or both. This way, the clamshell may be conveniently deployed to open to grasp a door handle, and conveniently un-deployed for storage—in an envelope for a shirt or pants pocket, for example.

Also, the top and/or bottom plates may be curved to better fit a door handle and be retained by the hand. The resulting shape may be nearly a truncated cone, with two, spaced-apart longitudinal slots which permit the cone to open up to receive and accept the door handle. Also, for example, a strap or pocket may be provided on either or both of the outside surfaces of the plates for receiving and securing the hand or one or more fingers.

Preferably, the instant door handle grasper may be made of plastic. The plastic may be thin enough to be flexible enough to adapt to fit the hand and a door handle. However, the plastic also needs to be thick enough to be firm-bodied, sturdy and durable, and preferably, at least top-compartment dishwasher safe. Also, the grasper may be of different, but combined, types of plastics, with, for example, a softer, stickier plastic with more friction on the inside of the top and/or bottom plates for more comfortably and securely grasping the door handle. Alternatively, the grasper plates may be a durable cardboard and/or other paper or other fiber-based materials.

### BRIEF DESCRIPTION OF THE DRAWINGS

FIG. 1 is a rear, bottom perspective view of one flat-plate embodiment of the present invention with a mechanical clasp near its distal end, the grasper grasping a door knob.

FIG. 2 is a front, top perspective view of the embodiment depicted in FIG. 1.

FIG. 3 is a top, side perspective view of the embodiment depicted in FIGS. 1 and 2 with a schematic hand of a user.

FIG. 4. is a top, front perspective view of the embodiment depicted in FIGS. 1-3, but without the doorknob or hand.

FIG. 5 is the view depicted in FIG. 4, but with the grasper closed and the mechanical latch engaged.

FIG. 6 is a side view of the view depicted in FIG. 4.

FIG. 7 is a side view of the view depicted in FIG. 5.

FIG. 8 is an exploded view of the view depicted in FIG. 4.

FIG. 9 is a top, side perspective view of another embodiment of the invention on a round door knob.

FIG. 10 is a top, side perspective view of the embodiment depicted in FIG. 9, but on an L-shaped door handle.

FIG. 11 is a top, side perspective view of the embodiment depicted in FIGS. 9 and 10, but without the door knob or handle.

FIG. 12 is a side view of the view depicted in FIG. 11.

FIG. 13 is the view depicted in FIG. 12, but in the closed position.

FIG. 14 is a top, perspective view of yet another embodiment of the invention.

FIG. 15 is a side view of the view depicted in FIG. 14.

FIG. 16 is a top, side perspective view of the embodiment depicted in FIGS. 14 and 15, and with an envelope the invention fits within.

FIG. 17 is the view depicted in FIG. 16, but with the invention in the envelope.

FIG. 18 is a top, side perspective view of yet another, curved embodiment of the invention grasping a door knob.

FIG. 19 is a top, side perspective view of the embodiment depicted in FIG. 18, but without the door knob.

FIG. 20 is the view depicted in FIG. 19, but with the grasper in the closed position.

FIG. 21 is a back, perspective view of an alternative embodiment, housed in an alternative housing that may be clipped to a user's belt, purse, or briefcase, for example.

FIGS. 22 and 22A are a front and a side cross sectional view, respectively, of the embodiment depicted in FIG. 21.

FIG. 23 a side, perspective view of the embodiment of FIGS. 21 and 22, showing an embodiment of a reel-in feature, wherein the grasping device is tethered to the housing by a cable or other tether, and is retractable by said cable or tether because of a spring-loading feature that pulls the grasping device back into the housing.

FIG. 24 is a top, perspective view of an embodiment of the grasping device in an alternative case/housing.

FIG. 25 is a perspective view of an embodiment of the grasping device in open configuration and illustrating how the friction pad may be replaceable when it becomes dirty or worn. Both the upper and lower friction pads in this figure may be removed and replaced. It may be noted that said friction pad may also comprise layers, surfaces, chemicals, or other compositions of matter or structures that are anti-bacterial. The friction/anti-bacterial pad may be replaced preferably with another self-adhesive friction/anti-bacterial pad.

FIGS. 26 and 26A are side, perspective views of another embodiment of the grasping device is an open and closed position, respectively.

FIGS. 27 and 27A are an open top, perspective view, and a closed side view, respectively, of another embodiment of the grasping device.

FIGS. 28 and 28A are an open top, perspective view and a closed side view, respectively, of another embodiment of the grasping device.

FIG. 29 is a back, top perspective view of another embodiment of the grasping device, wherein an elastic band on the outside of the plates is provided to urge the device to open, rather than a spring or other member of a hinge.

FIGS. 30 and 31 are top, front and back perspective views, respectively, of another embodiment of the grasping device, wherein an elastic member is provided to urge the device to open, rather than a spring or other feature of the hinge, and the elastic member is hidden substantially within a channel space within the walls of the plates, and secured to a metal bar at each distal ends of the plates.

FIG. 32 is a top, side perspective view of another embodiment of the grasping device, wherein an identification card, or other card with photograph(s), numbers, medical information, financial or credit card information or other information, advertising, or other indicia, is connected to one plate of the device. In this embodiment, the card is connected by its corners being received under corner flaps/tabs of the device.

FIG. 33 is a top, side perspective view of another embodiment of the grasping device, wherein an identification card, credit card, or other card with photograph(s), numbers, medical information, financial or credit card information or other information, advertising, or other indicia, is connected to the device. In this embodiment, the card is connected in a way that places a portion of it in a position that overhangs an edge of the device. This way, the card may be easily grasped and/or swiped through a card reader. Preferably, the overhanging portion comprises a magnetic strip or other information conveying device. FIG. 32A portrays an embodiment wherein an identification card, credit card, or other card with photograph(s), numbers, medical information, financial or credit card information or other information, advertising, or other indicia, is connected to the device by having its two ends slid beneath two end sleeves on a plate of the device. FIG. 32B portrays an embodiment wherein an identification card, credit card, or other card with photograph(s), numbers, medical information, financial or credit card information or other information, advertising, or other indicia, is connected to the device by being slid into a sleeve that covers most or all of an outside surface of one of the plates of the device.

FIG. 34 is a top, side perspective view of another embodiment of the grasping device, wherein a chip or other holder of information is included on a side of the device. For example, the chip or other holder may hold readable identification information, numbers, medical information, financial or credit card information or other information, advertising, or other indicia. In this embodiment, the chip is generally centered on one outer surface of the device, but one or more chips could be instead positioned on other areas or surfaces, as long as the chip is easily readable by swiping the chip-containing area against a reader or other sensor, or by passing the chip-containing area close enough to a proximity sensor.

### DETAILED DESCRIPTION OF THE INVENTION

Referring to the Figures, there is shown several, but not all, embodiments of the present clamshell door handle grasper invention. While the device is preferred for door handle grasping, it may also or instead be used for other things, such as protecting the hands or fingers from pathogens on other items/objects to be grasped or touched, protecting an item or object from fingerprints, and/or protecting the hand or fingers from damage, staining, or other problems potentially caused by the item/object.

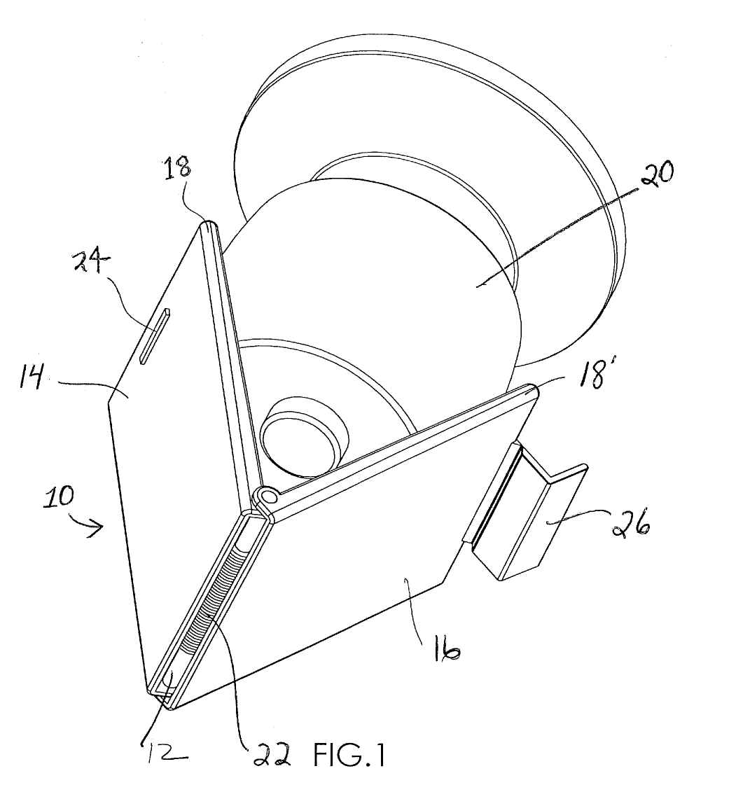

FIG. 1 depicts a first embodiment of the instant invention. Grasper 10 has hinge 12 near its proximal end. Hinge 12 connects top plate 14 and bottom plate 16. Plates 14 and 16 are generally rectangular and generally flat. The plates may have raised edges 18 and 18′, respectively, in order to create two open trays for receiving the door handle 20. Between plates 14 and 16, and along hinge 12 may be spring 22 for biasing the grasper 10 to open. Near the distal ends of both plates 14 and 16 are components for a mechanical latch for keeping grasper 10 closed. On plate 14, for example, is keeper bar 24. Also, on plate 16, for, example, is keeper swivel latch 26 which interacts with keeper bar 24 to keep grasper 10 closed.

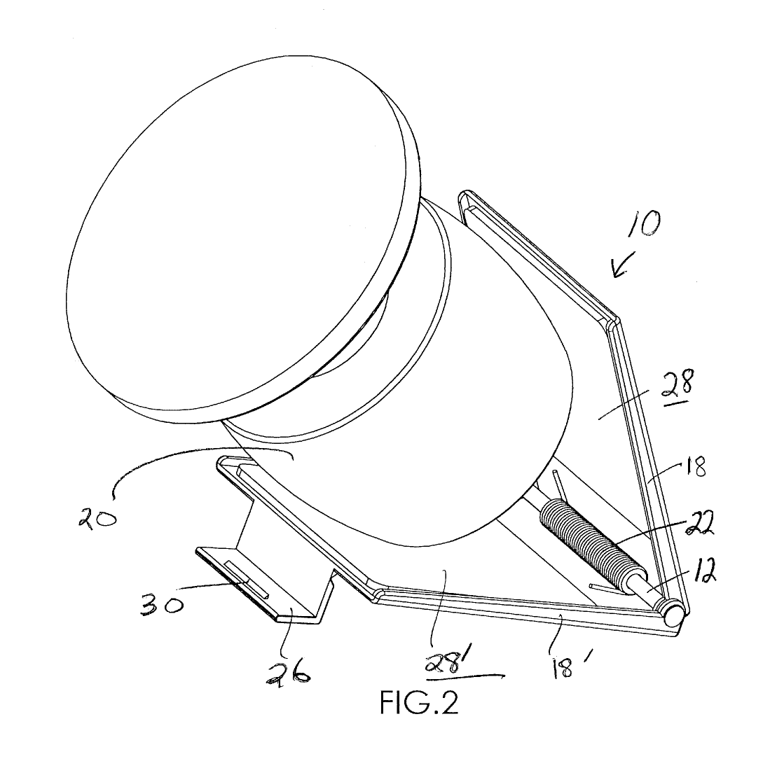

In FIG. 2 are visible most of the components depicted in FIG. 1, except a clear view of plates 14 and 16 is not available. This is because on the inside surfaces of plates 14 and 16 are friction pads 28 and 28′, respectively. Pads 28 and 28′ are provided for enhanced gripping/grasping of the door knob 20 by plates 14 and 16, respectively. For this service, pads 28 and 28′ may be of stickier, softer, more resilient material than for plates 14 and 16. Or, in the alternative, pads 28 and 28′ may be impregnated with pumice or other grit to increase their coefficient of friction for better grasping door knob 20.

Preferably, pads 28 and 28′ may be selectively removable and replaceable. This way, the pads may be refreshed to restore their gripping capability. Alternatively, pads 28 and 28′ may be removed and replaced to install new, clean pads, not contaminated by contact already with dirty door knobs and handles. Also, alternatively, the pads may be made of anti-microbial materials, for example, plastic impregnated or infused with a metal, like silver. Or, the pads may be adapted to be compatible with add-on anti-microbial aerosols, gases, gels, or liquids, etc.

Also available for viewing for the first time in FIG. 2 is keeper edge 30 on the inside of keeper swivel latch 26. Keeper edge 30 cooperates with keeper bar 24 depicted in FIG. 1 to maintain grasper 10 in the closed position when the mechanical latch 26 is engaged.

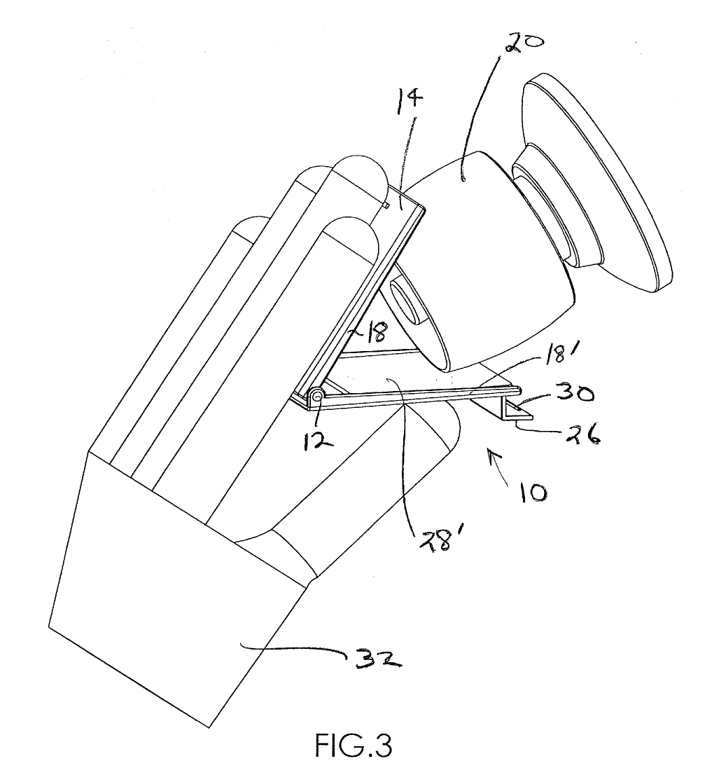

FIG. 3 depicts the embodiment depicted in FIGS. 1 and 2, but also depicts schematic hand 32 of a user of grasper 10. Grasper 10 may be made available in any convenient size. For example, different sizes for youth, women and men users are contemplated. Also, some users may be comfortable with using only the thumb and one or two fingers, for example, the index and middle fingers, instead of three or four fingers as shown in FIG. 3. Therefore, any convenient shape for grasper 10 is also contemplated. For example, grasper 10 may be made available in longer, narrower versions, as well as in shorter, wider versions. In addition, versions with rounded shapes, or with shapes similar to other comfortable or fanciful silhouettes, are also contemplated.

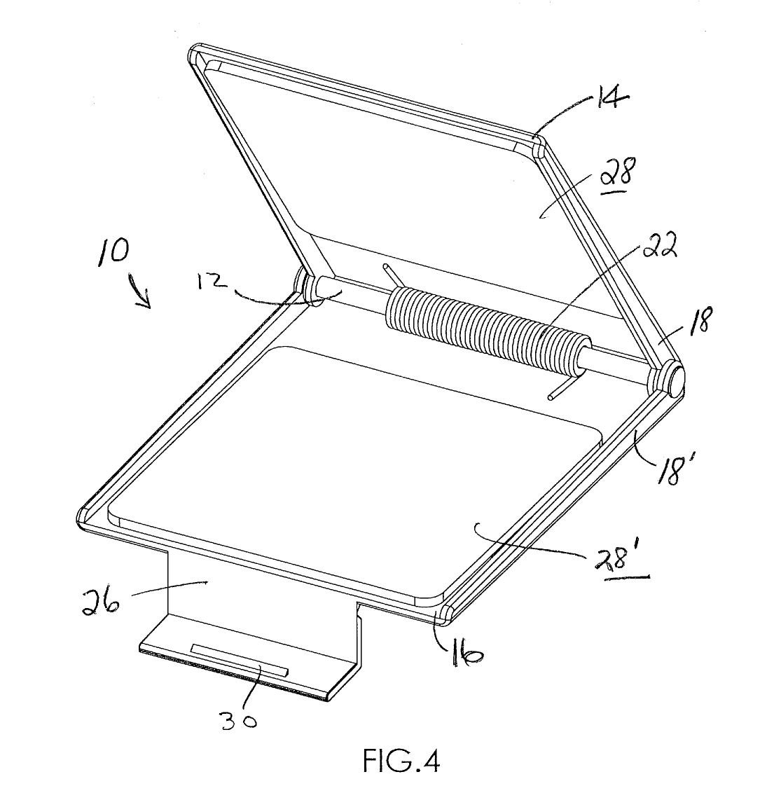

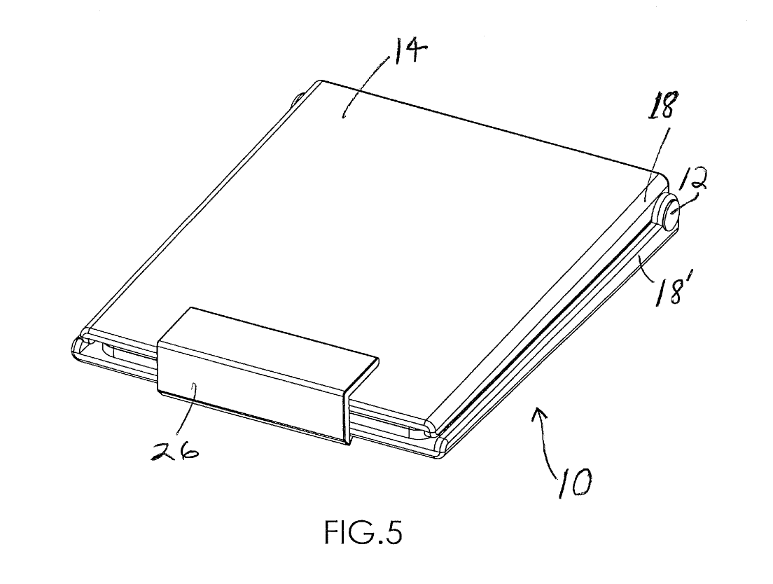

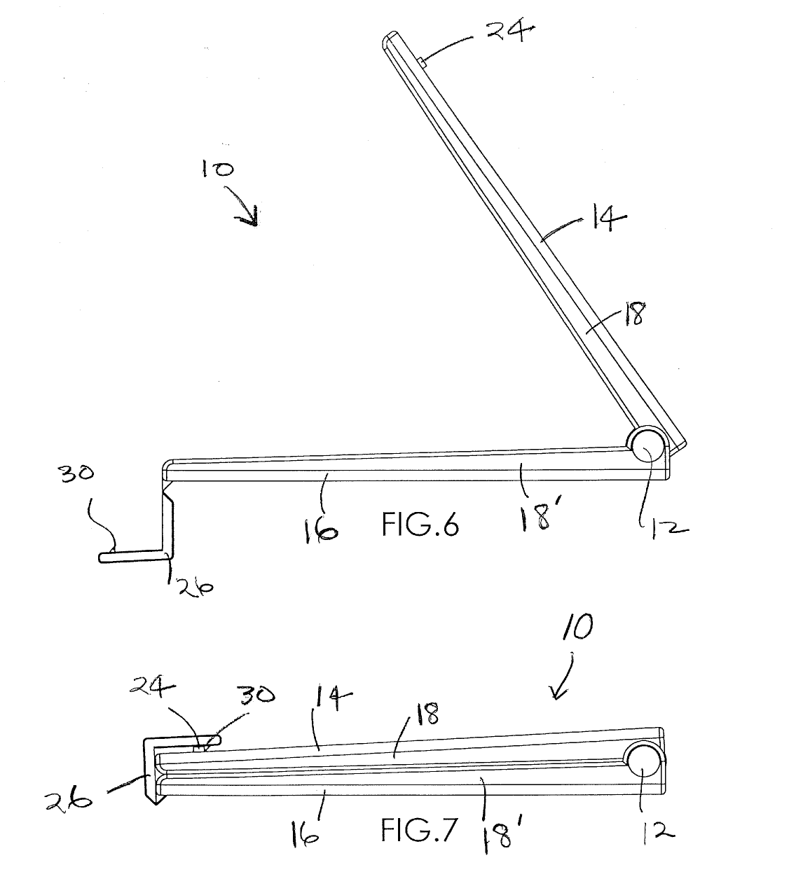

FIGS. 4-8 depict other additional views of the first embodiment depicted in FIGS. 1-3. In particular, mechanical latch 26 is depicted as a keeper swivel latch. Keeper edge 30 on latch 26 cooperates with keeper bar 24 on the distal, outer surface of plate 14 to maintain the grasper 10 in a closed position as depicted in FIG. 7.

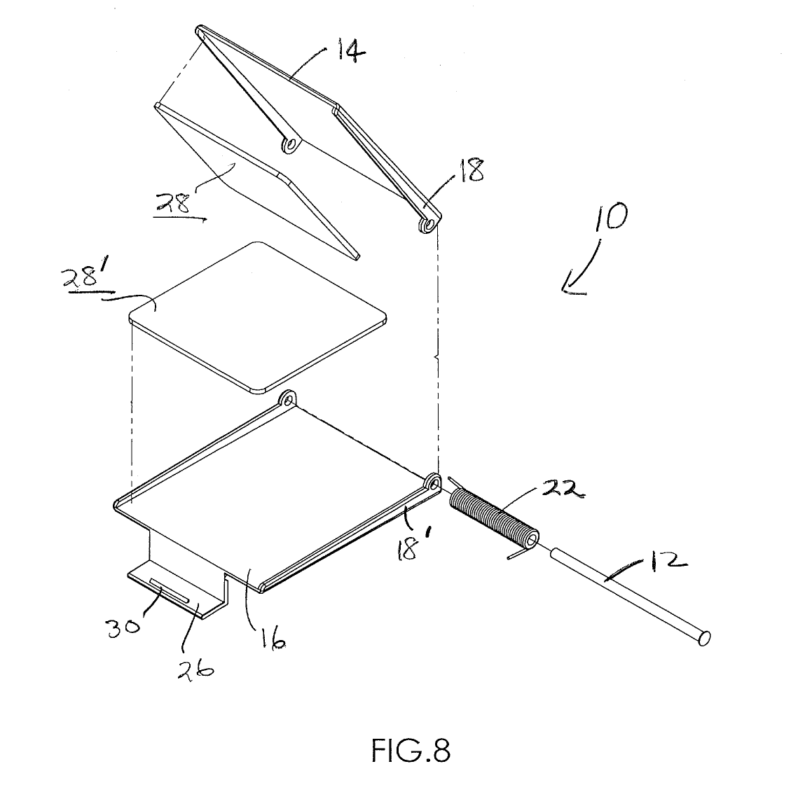

Also in exploded FIG. 8 pads 28 and 28′ are depicted as being separable from plates 14 and 16, respectively. However, pads 28 and 28′ may be integral within plates 14 and 16, respectively, as in a dual-density type molded product. Alternatively, pads 28 and 28′ may also be tablets of pluralities of thin sheets of material, the individual sheets of which may be selectively torn off for removal for disposal after use, leaving a fresh sheet available for the next use.

Grasper 10 may be made from conventional materials by conventional techniques. For example plates 14 and 16 may be made of thin, but durable, plastic. Also, hinge 12 as shown may be made with a metal or plastic rod. However, hinge 12 may also be made integrally, for example with cooperating shoulders on raised edges 18 and 18′, in which case no rod may be required. Also, hinge 12 may be as simple as an easily repeatably foldable section of plastic which connects plates 14 and 16. In this case the bias provided by spring 22 may be provided instead by the “memory” in the easily repeatedly foldable section.

Even if the bias in spring 22 or its equivalents is minimal, grasper 10 may be additionally encouraged to open by gently squeezing its edges 18 and 18′. This squeezing will result in a slight deformation of the plates 14 and 16, and in many cases may be enough to even disengage latch 26 from keeper bar 24.

In addition, for additional ease of handling, a pocket or strap may be provided on the outside surface of plate 14 and/or plate 16. This pocket or strap may be of the types disclosed in U.S. Pat. Nos. 2,695,999 (Arnold), 5,987,645 (Teaster) and 6,912,728 (Panella). In this vein, the pocket or strap may be made at or near the distal outside end of a plate 14 or 16 by an extending flap of material for pad(s) 28 and/or 28′ which folds back and/or sideways over or near the outside end of the plate. Alternatively, the pocket or strap may be made at or near the distal end of a plate 14 or 16 by a loop of material extending transversely from or secured transversely to the outside end of the plate. Alternatively, the pocket or strap may be made by providing appropriate slits in the outside surface of the plate's material to make some of the material loose enough to accept the user's fingers and/or thumb.

The grasper of the present invention is “firm bodied”. This means it has a generally constant shape in any gravitational orientation, subject to distortion and flex from forces during use, for example. The distortion and flex may be with or without “memory” built into the plates 14 or 16 material. Some users may repeatedly use grasper 10 to touch a particular object, and a modified shape of the grasper at rest may be desired. In this case, substantial, built-in “memory” in the plates' material may be optimum, so that the grasper may be adapted to become more customized for that particular use by bending to shape it and have it remain in that shape. Other users may often encounter many differently-shaped objects to grasp, so a more uniform shape of the grasper may be desired. In this case, substantially little built-in “memory” may be provided, so that the grasper, after each use, returns to about its original shape. In contrast, for example, the hand shields of Teaster (U.S. Pat. No. 5,987,645) and Panella (U.S. Pat. No. 6,912,728) are plastic films which deform easily under the force of gravity, and are not “firm bodied”. In fact, the grasper 10 is preferably firm, sturdy and durable enough to be cleaned and sanitized in a kitchen dish washer. This way, the grasper may be conveniently washed, sanitized and re-used, without contributing to the world's solid waste disposal problem.

In this environmentally friendly vein, even when pads 28 and 28′ are tablets of removable sheets, this is substantially less solid waste than a complete hand shield of the Teaster and/or Panella type. This advantage will be maximized when the pad's 28 and 28′ material itself is biodegradable.

Also, plates 14 and/or 16 may be made with a sleeve of additional material on the outside to receive identification (i.d.). and credit cards, for example. In this case the sleeve may extend substantially over the entire outside of the plate(s) 14 and/or 16. Alternatively, the sleeve may extend over only a portion of the outside of the plate(s). Preferably, at one end of the sleeve is a slit for allowing the sleeve material to be conveniently lifted and separated from the outside of the plate(s), so that the card(s) may be inserted. In addition to i.d. and credit cards, business cards, photos, notes, money, etc. may also be inserted within the sleeve. This way, grasper 10 may be conveniently made available as a wallet, or card holder, as well as a grasper. Alternatively, small packages containing anti-microbial soups, lotions, liquids, gels or aerosols may also be stored within the sleeve for storage for re-charging the anti-microbial activity, for example, of the pads 28 and 28′.

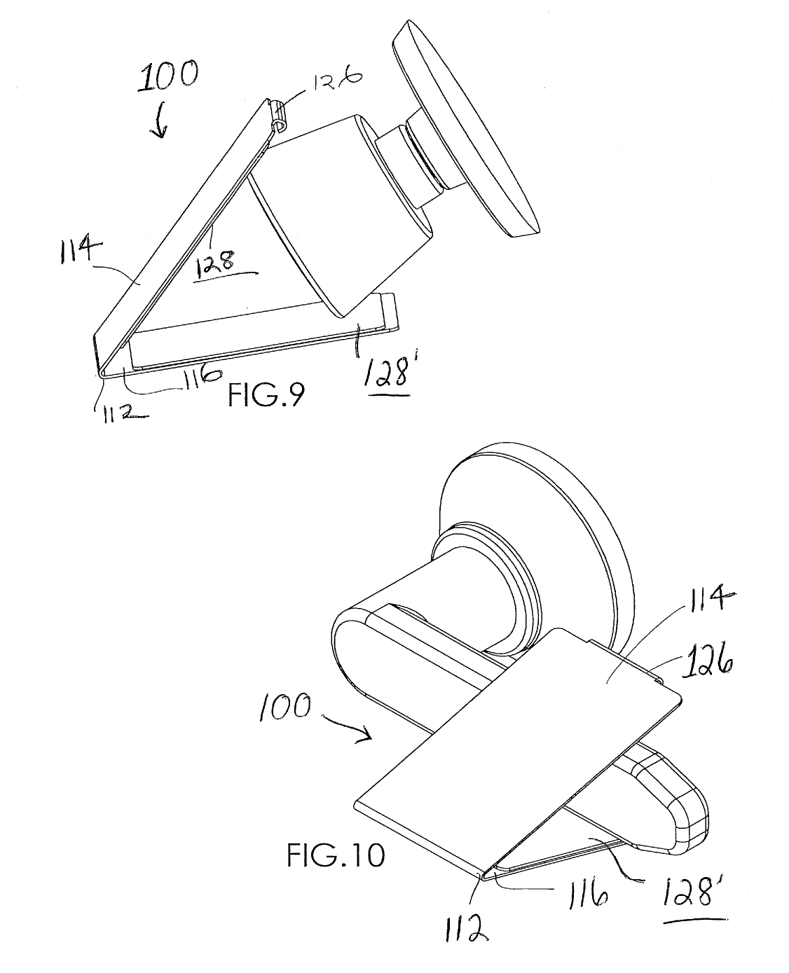

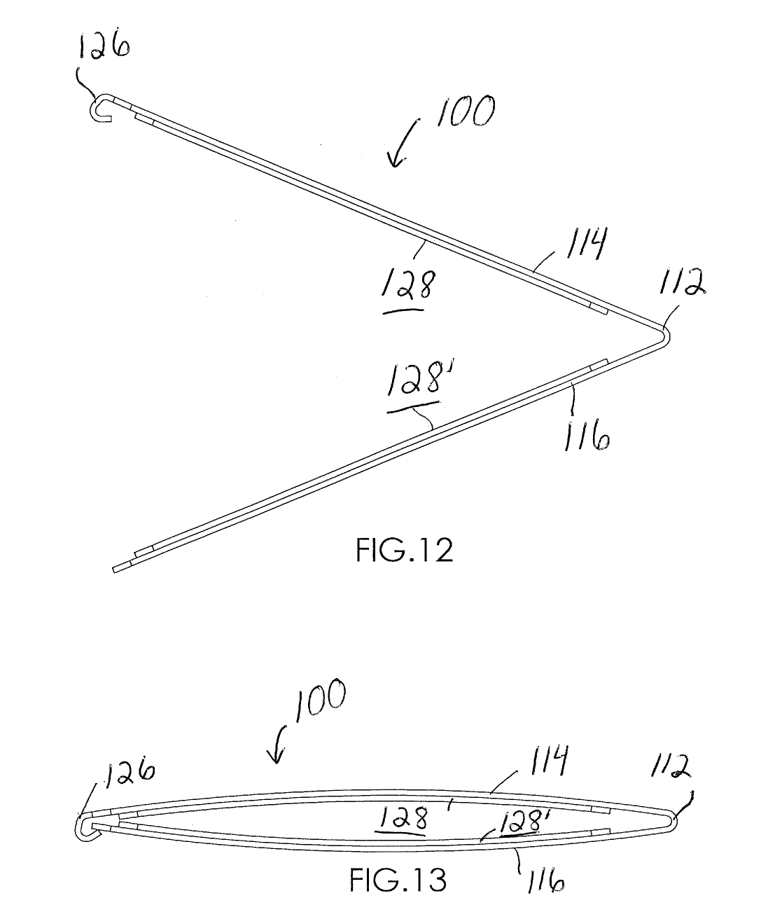

FIGS. 9-13 depict different views of a second, alternative embodiment of the present invention. This embodiment 100 of the instant grasper is thinner and sleeker than the first embodiment depicted in FIGS. 1-8, particularly in that the second embodiment lacks the upstanding edges 18 and 18′ of the first embodiment discussed above. Still, grasper 100 has hinge 112, and top plate 114 and bottom plate 116. For this embodiment of the invention, “memory” in the plastic which forms the hinge 112 tends to bias grasper 100 in the open position. To maintain grasper 100 in the closed position, it has mechanical hook latch 126 on the distal end of plate 114 which interacts with and secures the distal end of plate 116. Also, grasper 100 has gripper pad 128 on the inside surface of plate 114, and gripper pad 128′ on the inside surface of plate 116 for enhancing the grasping capability of grasper 100.

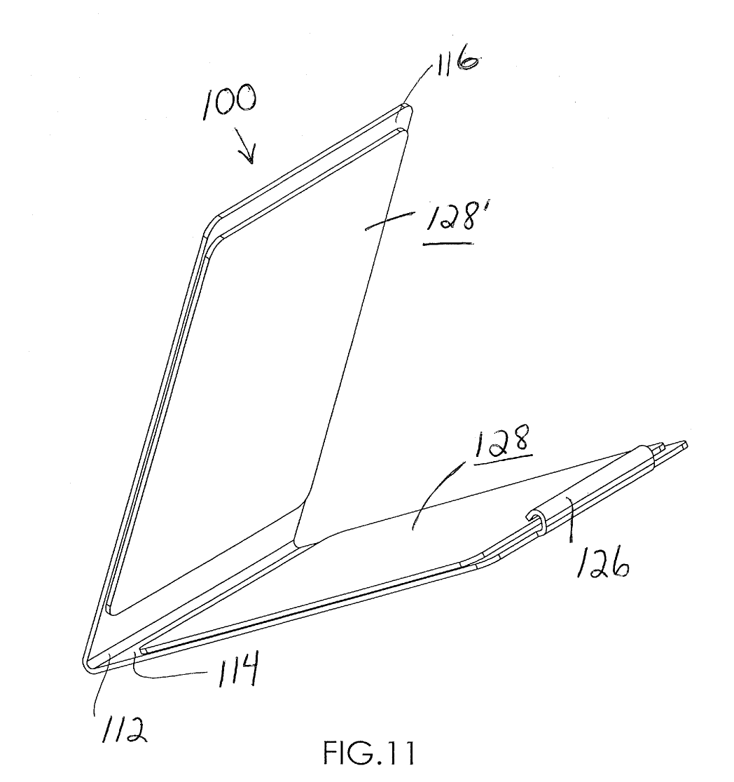

FIGS. 11-13 depict other views of the second embodiment depicted in FIGS. 9 and 10. In particular, mechanical latch 126 is depicted as a partly cylindrical hook latch on the distal end of plate 114 which cooperates with and secures the distal end of plate 116 for maintaining grasper 100 in the closed position.

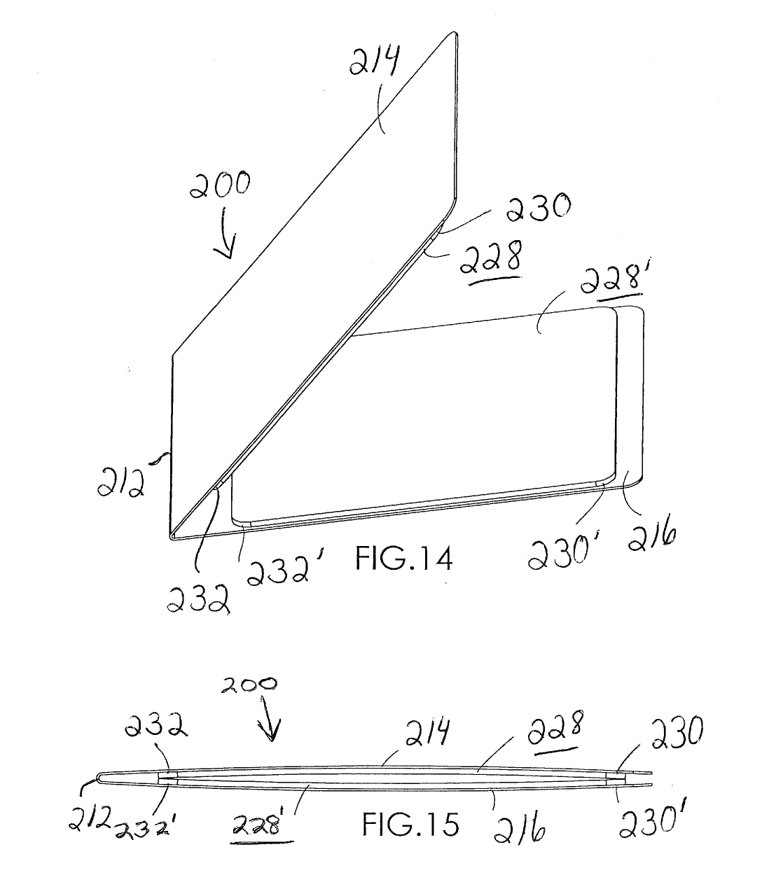

FIGS. 14-17 depict different views of a third, alternative embodiment of the present invention. This embodiment 200 of the instant grasper is even thinner and sleeker than the second embodiment 100 discussed above. Still, grasper 200 has hinge 212 connecting top plate 214 and bottom plate 216. On the inside surface of top plate 214 is gripper pad 228, and on the inside surface of bottom plate 216 is gripper pad 228′. Additionally, at the distal end of pad 228 is magnetic closure outer strip 230, and at the distal end of pad 228′ is magnetic closure outer strip 230′. These magnetic strips 230 and 230′ cooperate with one another to close grasper 200 and maintain it in the closed position. Optionally, grasper 200 may also have magnetic closure inner strip 232 on or near the proximal end of pad 228, and magnetic closure inner strip 232′ on or near the proximal end of pad 228′ to also assist in closing grasper 200 and maintaining it in the closed position.

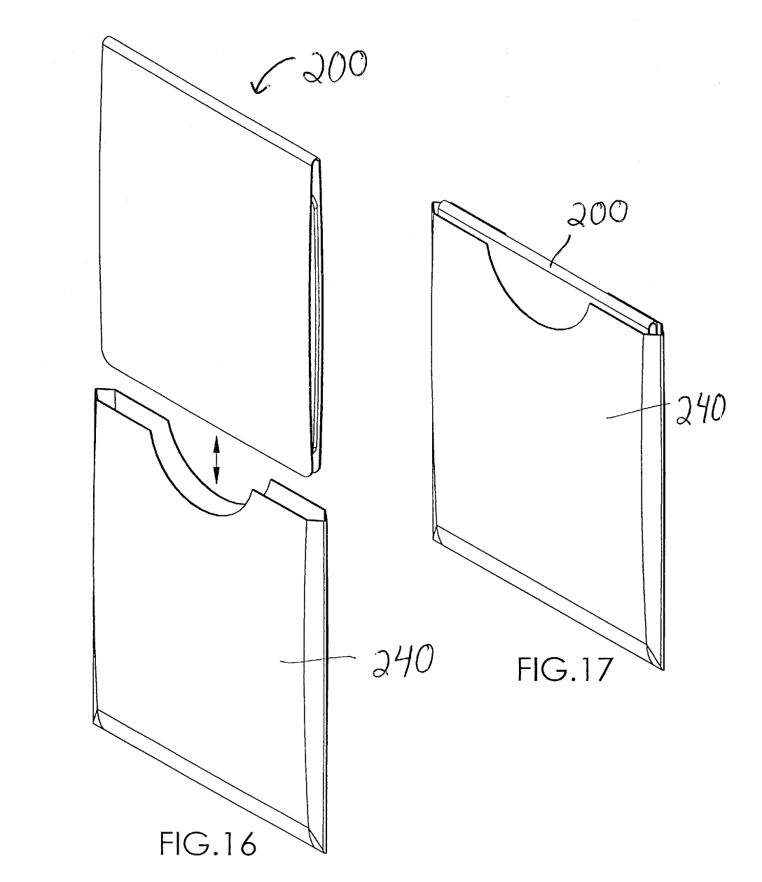

When closed, grasper 200 may be conveniently inserted into envelope 240 for convenient storage, as depicted in FIGS. 16 and 17.

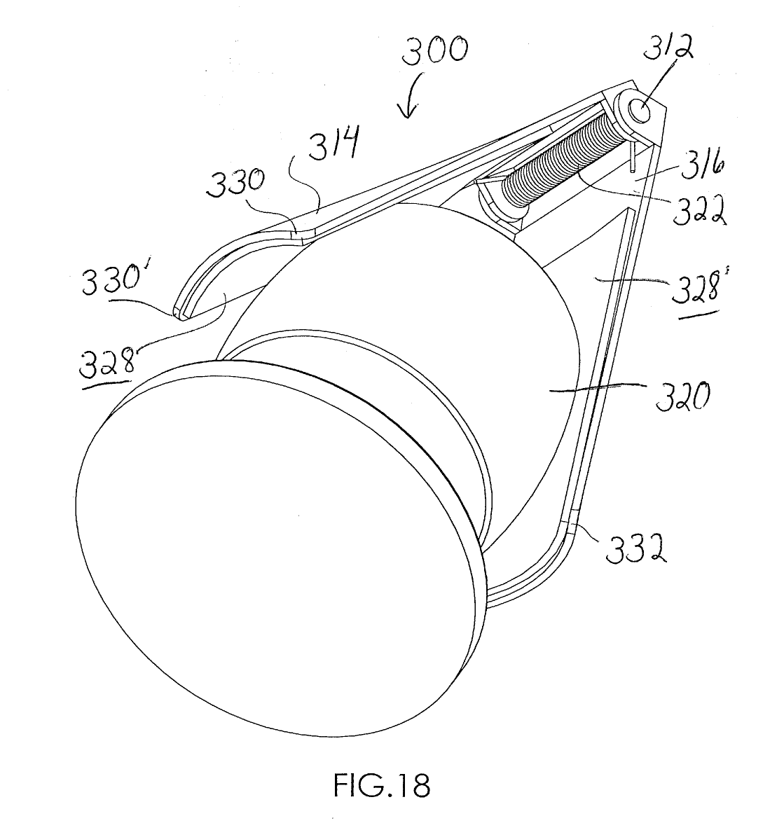

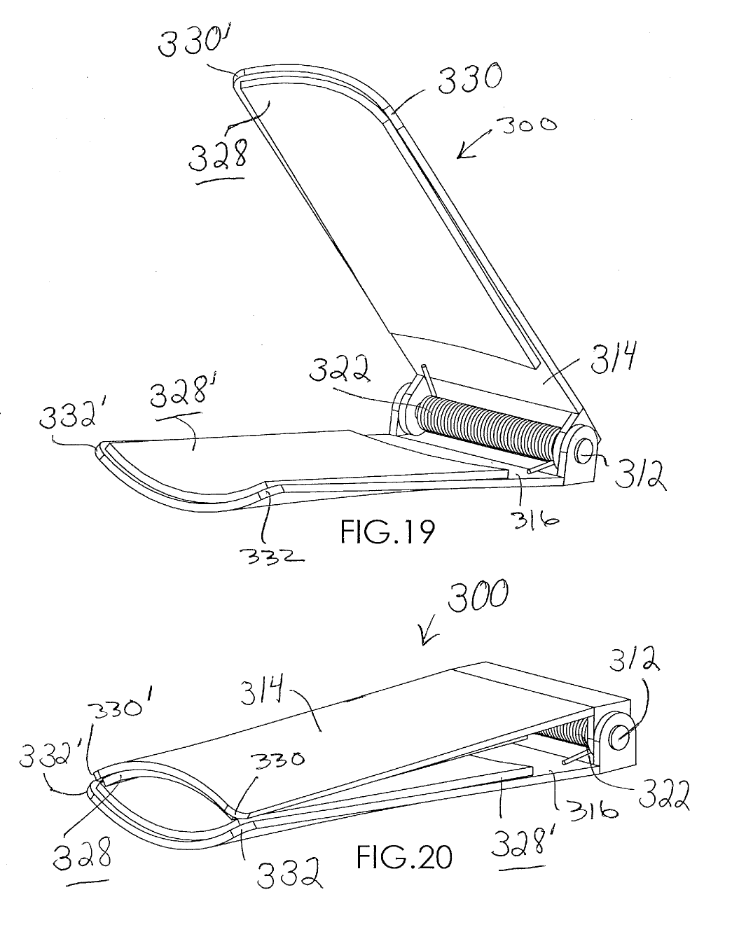

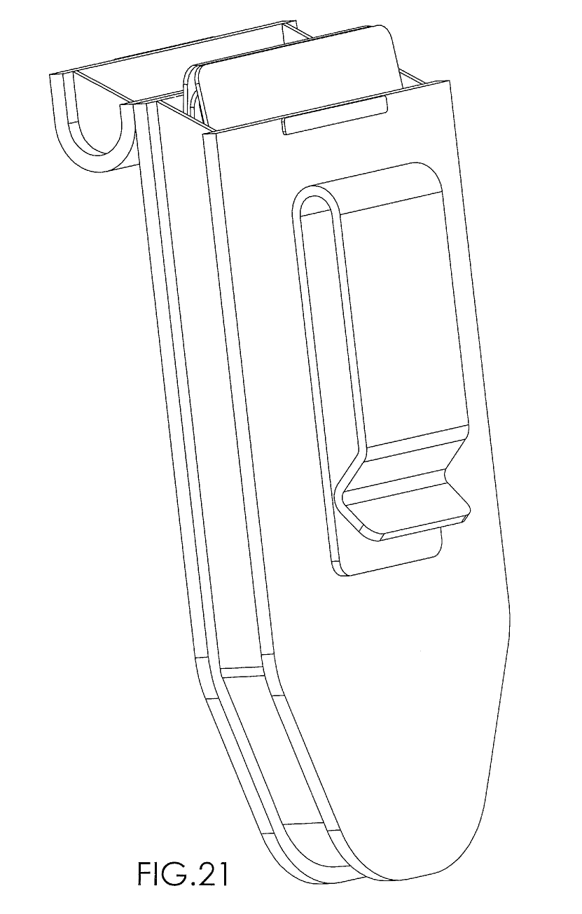

FIGS. 18-20 depict different views of a fourth, alternative embodiment of the present invention. This embodiment 300 of the instant grasper has curved upper plate 314 and curved lower plate 316 connected by hinge 312. Hinge spring 322 biases the plates 314 and 316 apart to open the grasper 300. On the inside surface of top plate 314 is gripper pad 328, and on the inside surface of bottom plate 316 is gripper pad 328′. Additionally, at or near the distal end of top plate 314 are two magnetic top spots 330 and 330′ which cooperate with two magnetic bottom spots 332 and 332′, respectively (bottom spot 332′ not shown), at or near the distal end of bottom plate 316 for closing grasper 300 and maintaining it in the closed position. Grasper 300 is shown grasping round door knob 320.

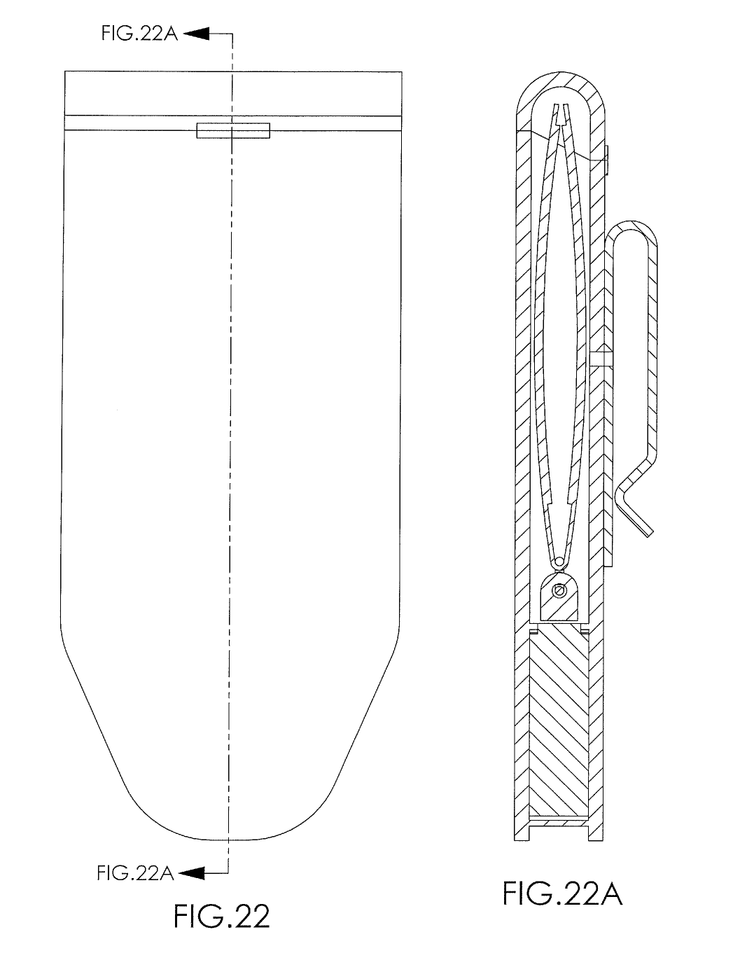

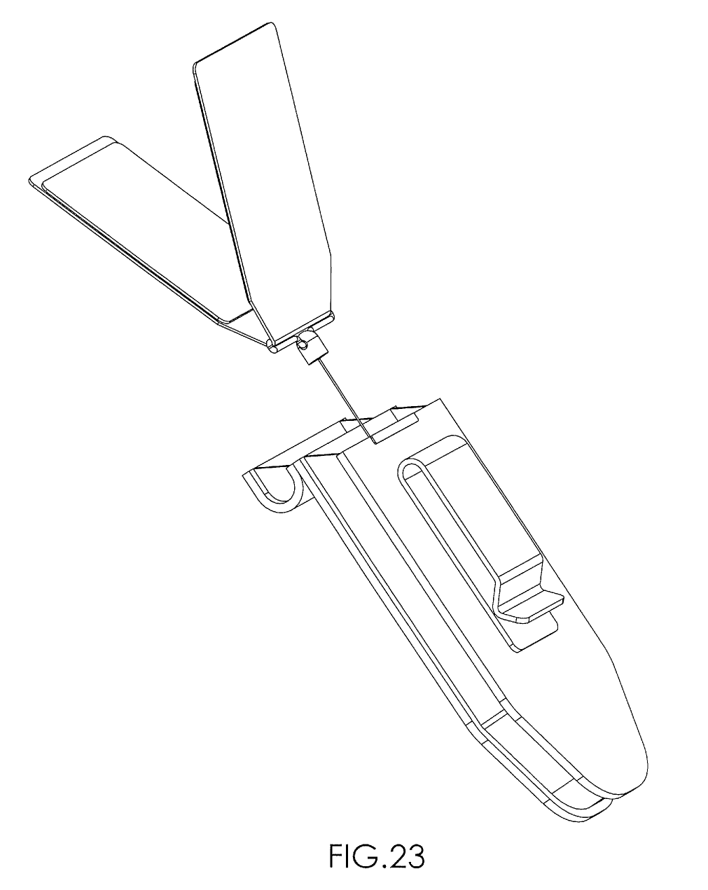

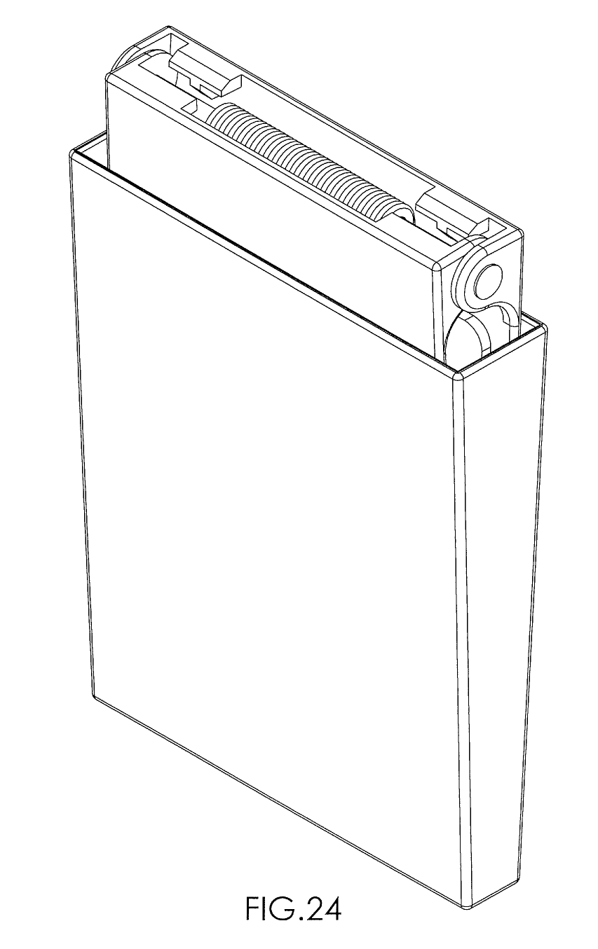

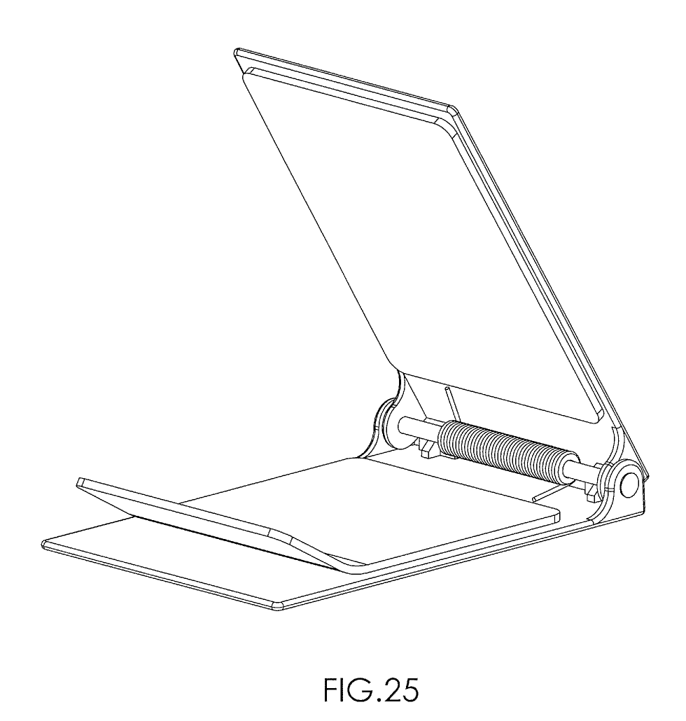

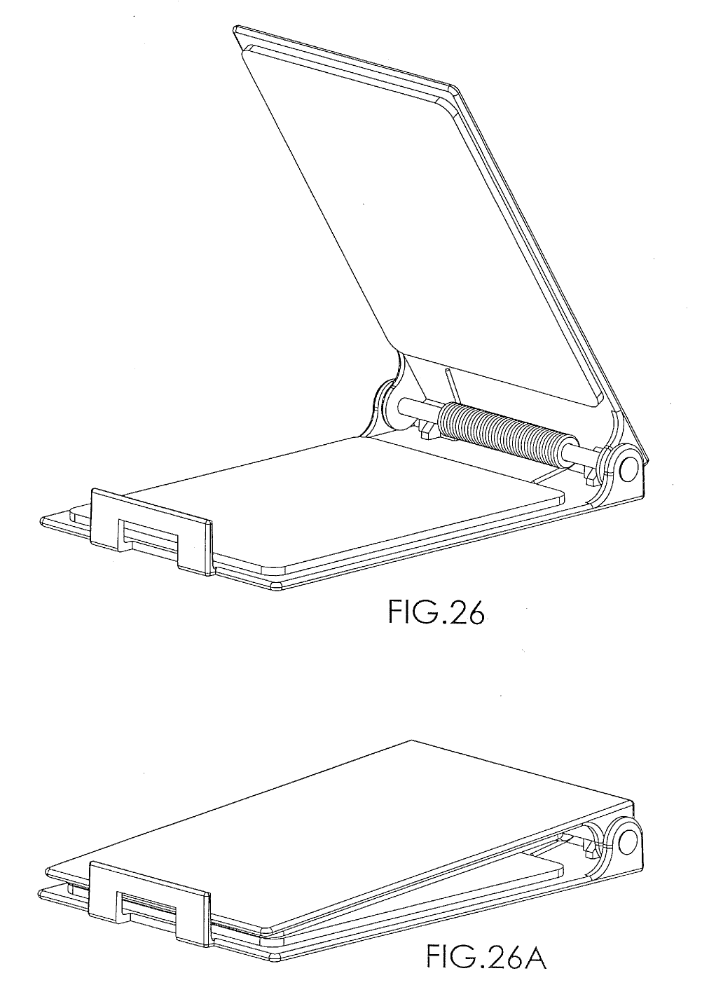

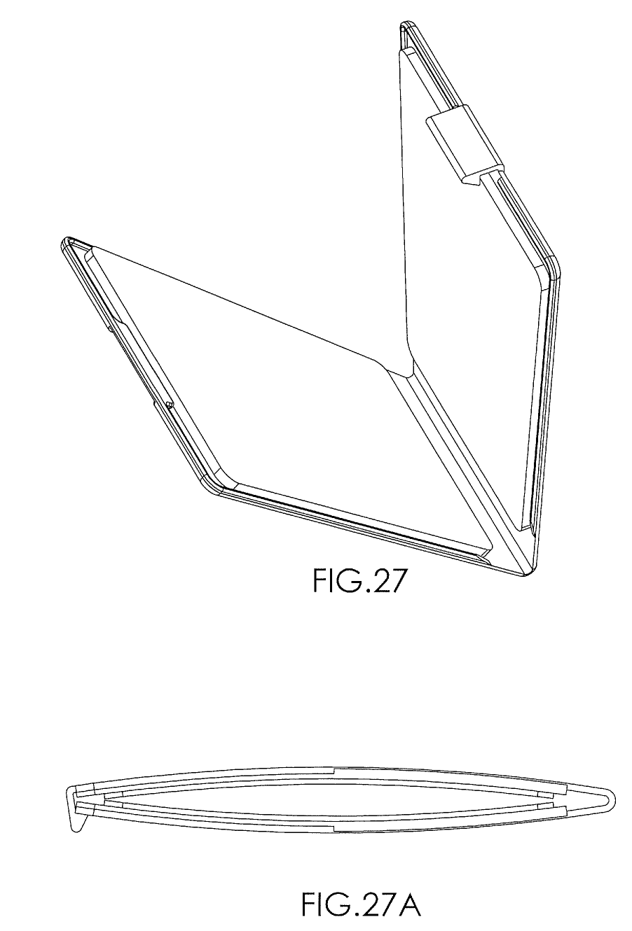

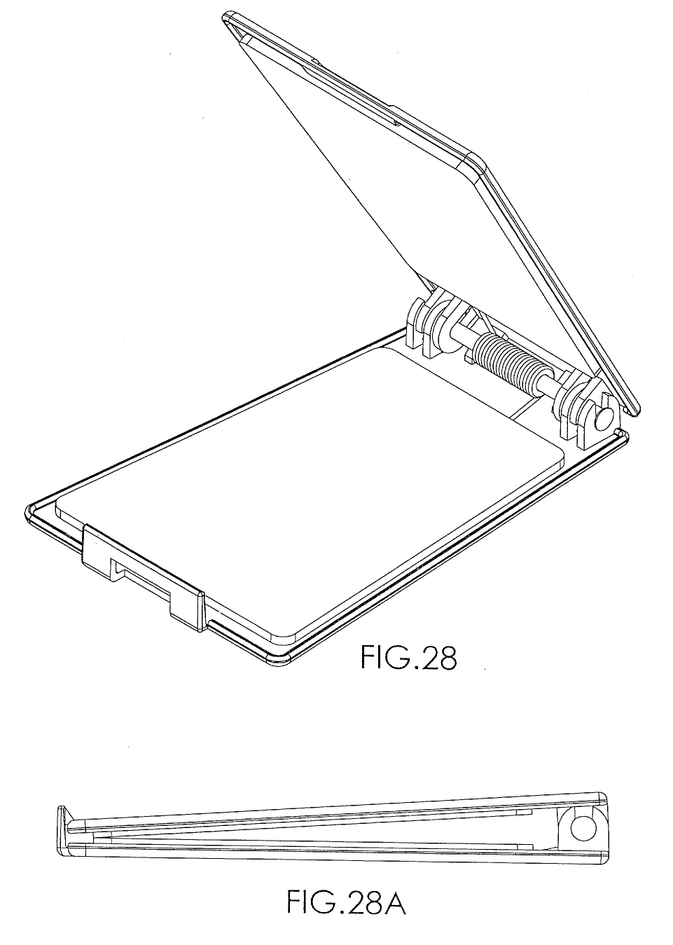

In following FIGS. 21-34, one may see alternative embodiments, including many of the features described above. The grasping device may be housed in various housings or cases, with said housings or cases optionally comprising a retractable cable system which tethers the grasping device to the housing/case and allows “hands-free” retraction back into the housing/case after use. After the user has pulled the grasping device out of the housing/casing, used the grasping device generally as described elsewhere in this document, and then lets go of it, then the spring-loaded system, which is preferably inside the housing/casing, quickly pulls the cable/tether back into the housing/casing without the user having to touch the device or manually insert it into the housing/casing.

The housing/casing may have a clip-hook or other latch to attach the housing/casing to a person's belt, purse, briefcase, notebook, or other worn or carried object. This hook/latch, combined with the retractable cable system, can improve convenience and efficiency of use of the device.

Alternatively, the grasping device may be tethered to a hook or other latch that may provide a “docking station” for the grasping device without enclosing the device in a housing/casing. The hook or latch may be adapted for attachment to a person's belt, purse, briefcase, notebook, or other worn or carried object. Also, the hook or other latch may comprise a retractable, spring-loaded cable system that will quickly pull the grasping device back to the hook/latch after use; preferably the spring-loaded cable system would pull the device against or close to the hook/latch, so the device does not swing, and so the user can easily and predictably reach for the device again when needed. This way, the grasping device is “docked” at or near the hook/latch, but is not enclosed or encased in a housing. The device will be closed when in this docked position (as it is when in a housing or casing), and the possibly-contaminated inner surfaces will not be easily contacted by the user.

The invented grasping devices, including those shown in the drawings and others, may comprise an anti-bacterial and/or other anti-pathogen features, for further shielding the user from bacteria and pathogens that may be picked up from the door knob or other item grasped. For example, the plastic plates (such as plate 14 and 16) may have anti-bacterial/anti-pathogen characteristics and/or have anti-bacterial/anti-pathogen chemicals embedded or attached to them. This would be especially preferred on the inner surfaces of the plates, that is, the portions facing the door knob or item to be grasped, but the outer surfaces may be anti-bacterial/anti-pathogen on or in their outer surfaces. The plates and/or one or more surfaces of the plates may be inherently anti-bacterial/anti-pathogenic and/or may have added anti-bacterial/anti-pathogenic characteristics. Or, if friction pads are used, the friction pads (such as 28 and 28′) may have anti-bacterial/anti-pathogen characteristics. Or, additional layers, films, strips, or sheets that have anti-bacterial/anti-pathogen characteristics may be provided over or adjacent to the plates and/or over or adjacent to the friction pads. Like the friction pads, such layers, films, strips, or sheets may, in some embodiments, be self-adhesive and removable/replaceable.

It is preferred that, if removable and replaceable friction pads are used, that they have anti-bacterial/anti-pathogen properties, so that, in a simple action of peeling off the friction pads and replacing them, both gripping characteristics (such as provided by a rubber-like or sponge-like material, or other tacky or gripping surfaces) and also the anti-bacterial/anti-pathogen characteristics may be supplied and maintained by providing and replacing a single layer on each inner surface of the places.

Various hinges may be used, for example, conventional spring hinges or other biased hinges. Hinges that are biased to open the device are preferred, so that the user need not manually open the device, but, rather, the device opens on its own once removed from its casing/sheath or a pocket or other containment.

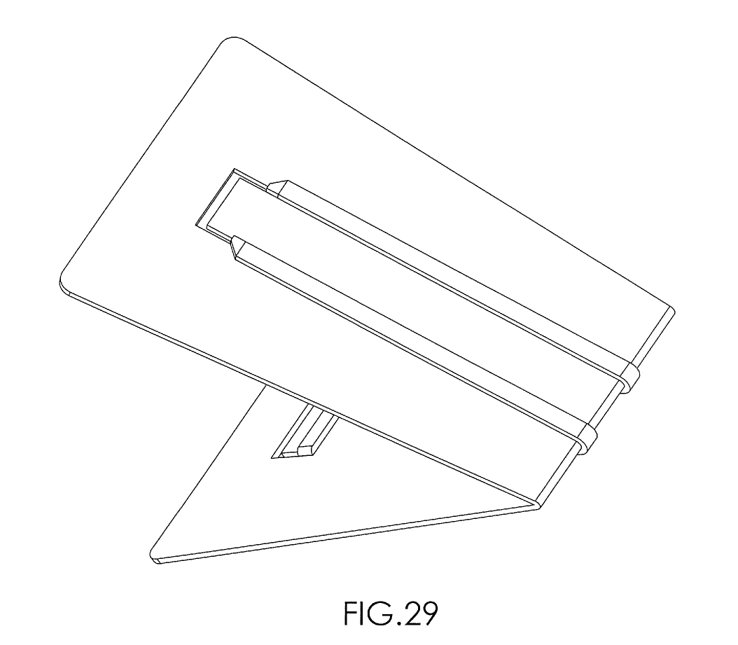

Alternatively, embodiments may be provided wherein the plates themselves and their crease/proximal-end-connection may have little or no bias into the open position, and there is no significantly-biased hinge at the crease between the plates. Instead, an elastic member(s) create(s) an opening-bias for the device as depicted, for example, in FIG. 29.

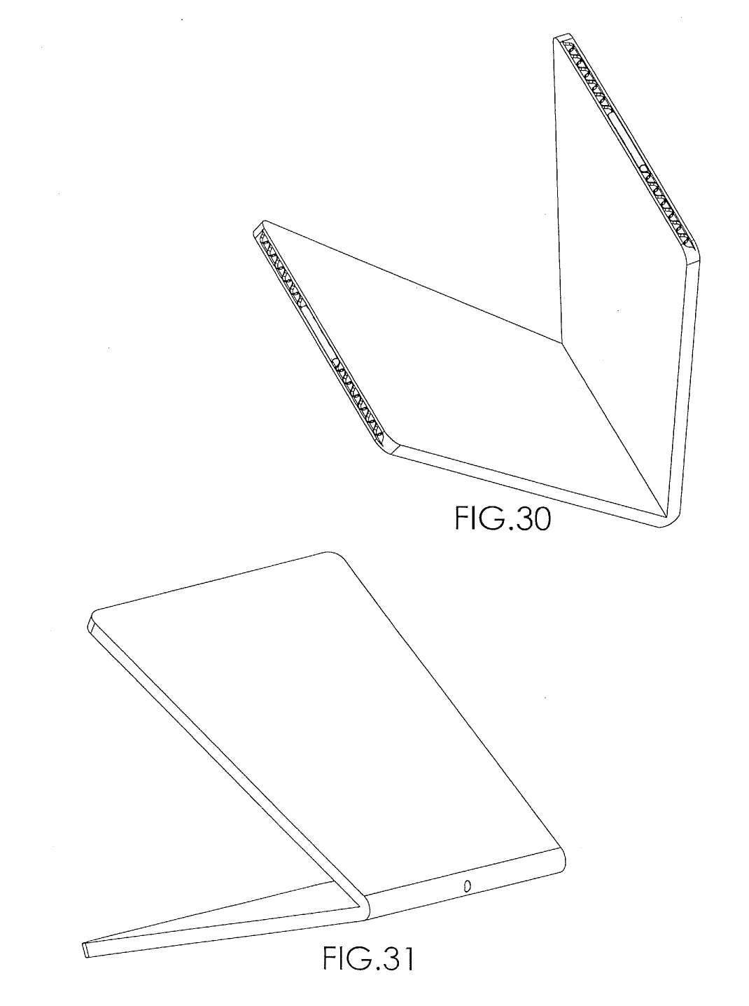

FIGS. 29-31 show examples of two, but not the only, embodiments that have an elastic band/member for creating the opening-bias. The device may be made from a single sheet of material folded at said one end to create the easily repeatably-foldable section/crease at the proximal end of the device, or, alternatively, may be two sheets connected together at their proximal ends to form the repeatably-foldable location. The elastic member(s) are curved around said crease/repeatably-foldable section, preferably on or near the outside of the device, and are attached to each of the plates at locations distal from the crease/section. This way, the elastic characteristic of said member(s) tend to urge said locations in directions outward and proximal toward the crease/section, which will act to open the device. If the elastic band(s)/member(s) is/are secured to at or near the outside of the plates (FIG. 29), the opening-bias is more easily obtained, but elastic band(s)/member(s) may be substantially within the plates (as in FIGS. 30 and 31) and still be positioned (and/or have the crease/hinge designed) so that the opening-bias is obtained.

For example, in FIG. 29, a single circular (endless) rubber band or other elastic member wraps around the crease/section, and extends to locations approximately ¾ of the way to the distal edges of the plates. Different locations may be used, for example, ½-⅞ of the way to from the proximal edges/crease to the distal edges. There, the rubber band hooks onto tabs (one on each plate) that are cut into the plates. This way, the bias of the rubber band keeps the band in place on the tabs, and also pulls the two plates apart (outward/proximally) when removed from the casing, housing, pocket, purse, or other container. The rubber band preferably extends continuously from near the distal edge of one plate, around the crease/section, to near the distal edge of the other plate. In this case, the rubber band extends substantially on the outer surfaces of the device, while in other embodiments, it may be seen that the elastic member(s) may be substantially hidden inside the device (FIGS. 30 and 31) or entirely hidden inside the device.

For example, in FIGS. 30 and 31, the plates of the device are made of corrugated sheets of materials, such as corrugated cardboard. The elastic member extends through a space between corrugations in each plate and it anchored to/around metal end pieces at the distal end of each plate. Thus, it may be said that this elastic member is an example, of an elastic member(s) that extends through a channel in the plates.

Although the elastic member in FIGS. 30 and 31 is substantially hidden from view, it is placed so that it urges the plates apart rather than together. Also, the crease/connection at the proximal end of the device may have some inherent bias to open the device slightly, so that the crease/connection bias and the elastic work together to establish forces that open the device. This approach may be especially useful in embodiments that have a latch to keep the device closed and/or that have a casing that urges the device closed. This way, as soon as the latch is brought out from the casing and/or as soon as it is unlatched, the inherent features of the plates and/or of the crease/connection, plus the bias of the elastic, serve to quickly open the device to an extent sufficient, for example, to grasp a doorknob.

Other embodiments may have one or more elastic members that extend(s) through a trough or recess in the plates, with covering or partial covering of the trough/recess being an option. Again, there are multiple ways within the broad scope of the invention to provide an elastic band/member bias that will tend to open the device, rather than requiring a more expensive and/or heavy hinge with a spring.

By “opening” the device, it is meant that the device is opened at least enough to fit around the object to be grasped. Typically, this will be 30 degrees or more, and more preferably, 45 degrees or more, but it typically need not be 90 degrees or more.

Alternative embodiments may be connected to a wearer or a wearer's carried objects, and may comprise information or indicia for various purposes. For example, the device may comprise a card, surface, or semiconductor chip that contains or comprises personal or corporate identification card, photograph(s), numbers, medical information, financial or credit card information or other information, advertising, or other indicia. This information or indicia may be connected as a separate but connectable card or chip, or may be integral with, or laminated into, the material of the grasping device. This way, a person may wear or carry a grasping device that also serves as an ID tag, credit card holder, medical emergency information holder, advertisement, or device for other secondary purpose. The device may be connected to the person on his/her belt, necklace or other strap or cord, or on a carried item such as a briefcase, purse, or notebook.

It is preferred that the card or chip or other information-carrying portion be easily accessible on the outside of the grasping device. This way, the card, chip, or other information-carrying portion may be shown at a door to an attendant or security officer, for example, or swiped against or in a card reader or against or in or close enough to another type of sensor device. Said reader/sensor device may be chosen from many current or future readers/sensors. For example, the device and its card, chip or other information carrying portion may be held by the grasping device and adapted to be read by the common reader such as installed in retail stores to read credit cards, or held and adapted to be read by the common reader such as installed in many hotel room doors. For example, a card may cover or comprise an area that is the entire surface area, or a portion of the surface area, of one or both plates of the device, that is, not extending beyond the outer perimeter edges of the device. Or, a card may overhang in one or more directions from the device to be swiped through a reader. A card may have an overhanging edge that is its long side edge, or that is its end edge. A card may be connected to, or integral with, one or both of the two plates/wings that are pivotally connected to form the main body of the grasping device, so that the card covers the entire, or substantially the entire, outer surface of the plate(s).

Information may be stored in the card, and read by a data input device, by many conventional means and/or may be printed or embossed onto/into the card. For example, conventional means may include card reader, memory card reader, or magnetic card reader technology, bar code readers, and/or other readers or sensors, including proximity sensors, and the stored information and/or codes that cooperate with such readers and/or sensors. Such systems may be beneficial, for example, for ID or other security clearance in a corporation, utility, military, hospital or clinic, government, or other setting. Such systems may be beneficial for people that must show or use information or a credit card frequently and prefer not to have to remove said information or credit card from a pocket, wallet, purse or briefcase.

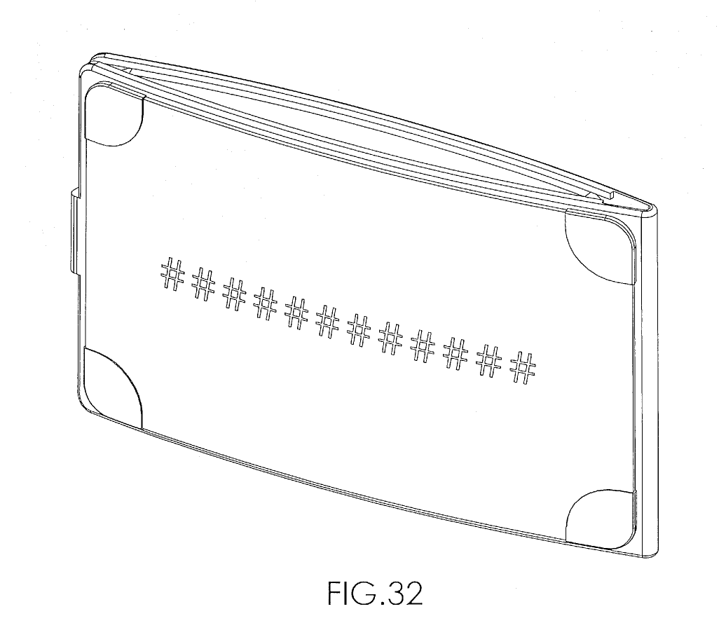

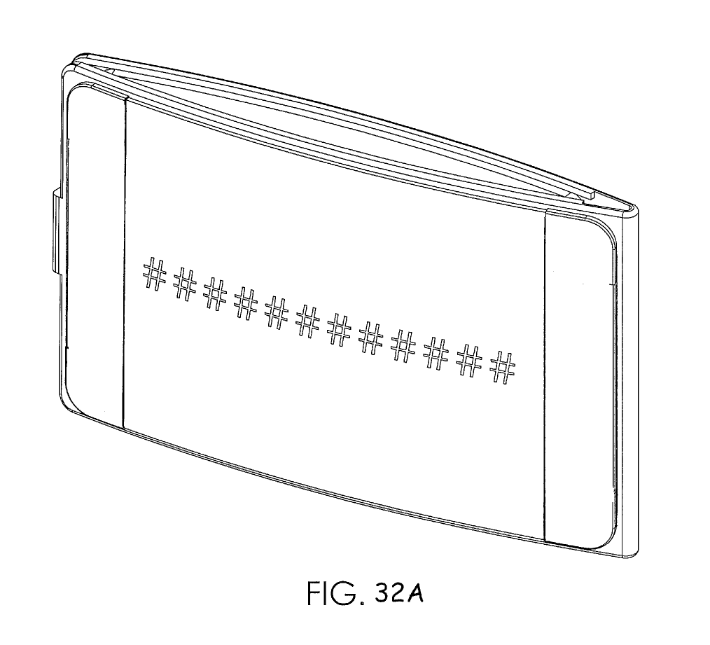

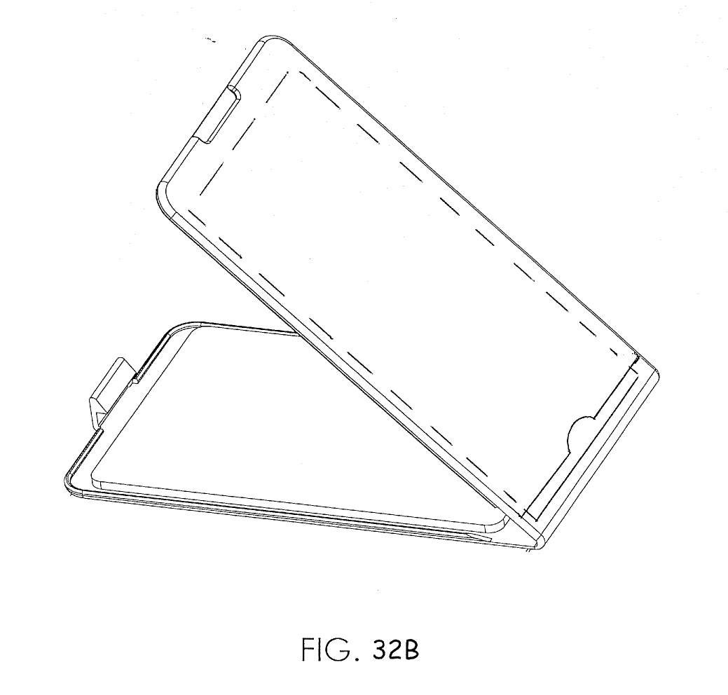

In the embodiment shown in FIG. 32, the card is connected by its corners being received under corner flaps/tabs of the device, as in the traditional corner tab system for connecting photos to a scrap/photo book. This way, the card may be removed, and/or cards may be switched out for various events or venues. The “#” marks on the card on the outer side of the grasping device, in FIG. 32, indicate that information or indicia may be placed on/in the card, for example, the information and/or codes discussed above to be read by a conventional card reader (such as a card reader, memory card reader, or magnetic card reader technology, bar code readers, and/or other readers or sensors, including proximity sensors), and/or information or indicia may be placed on the card for viewing and understanding by a person such as a security guard. Thus, information may include electronically-readable information and/or visible (human-readable) information. FIG. 32A portrays an embodiment wherein each end of at least one of said plates has a sleeve that partially-extends over the plate (rather than four corner tabs) so that the two ends of an i.d. card, credit card or other removable sheet may be inserted underneath the two end sleeves. FIG. 32B shows an alternative embodiment wherein at least one of the plates comprises a sleeve that covers most or all of the outer surface of said at least one plate. One may see the an open end of the sleeve (right side of drawing) and the dashed-line removable card (or money, or other sheet or object) that has been inserted through the open end and into the sleeve. A small end portion of the card in FIG. 32B protrudes from the sleeve for access and/or removal. Sleeves may be opaque, so that an observer may not know what is in the sleeve (for example, if money is in the sleeve) or the sleeve may be transparent or translucent for visually or digitally reading or otherwise viewing the card or other object inserted in the sleeve.

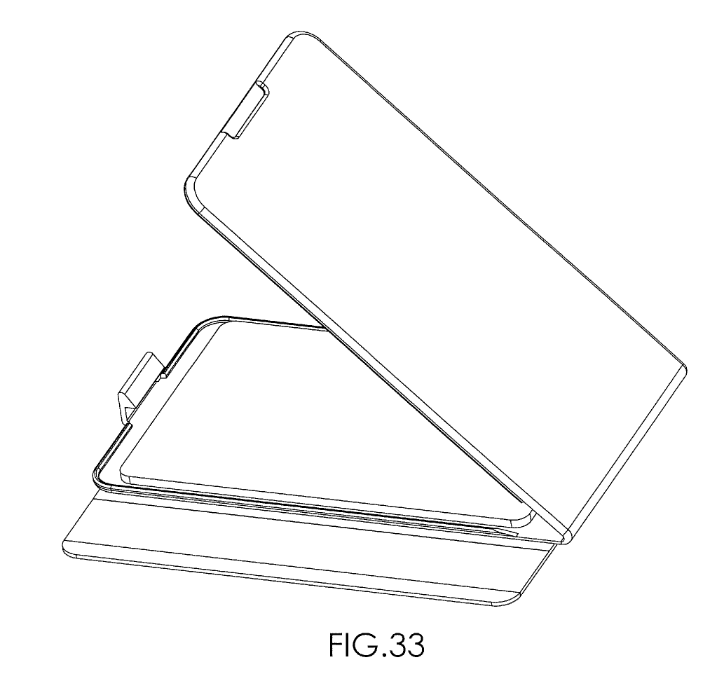

FIG. 33 is a top perspective view of an embodiment of the grasping device, wherein an identification card, credit card, or other card or protrusion overhangs an edge of the grasping device. The card or other plate/protrusion may contain photograph(s), numbers, medical information, financial or credit card information or other information, advertising, or other indicia, is connected to the device. Because the card is connected in a way that places a portion of it in a position that overhangs an edge of the device, the card may be easily grasped and/or swiped through a port of, or against a surface of, a card reader or other reader and/or sensor. Preferably, the overhanging portion comprises a magnetic strip or other information conveying device, and may also include printed information on a reverse side from the strip. Thus, information may include electronically-readable information and/or visible (human-readable) information. In some embodiments, the overhanging card may be fixed to the device, or may be inserted into a sleeve (not shown in FIG. 33) that retains the card in place.

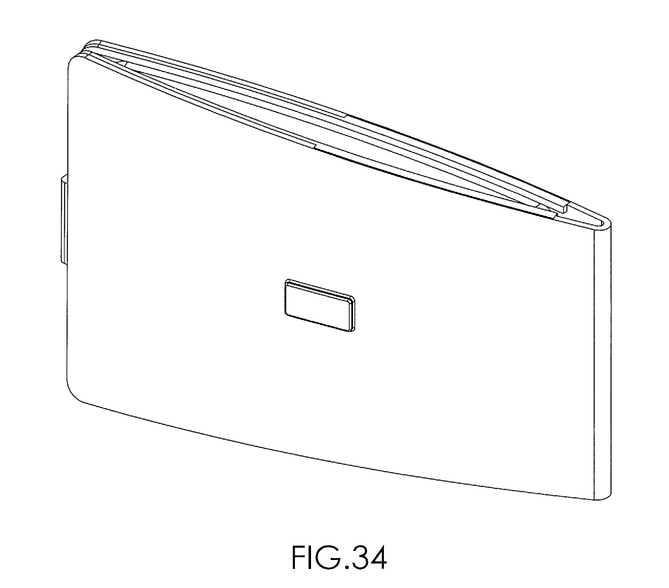

FIG. 34 is a side perspective view of another embodiment of the grasping device, wherein a chip or other holder of information is included on/in a side of the device. For example, the chip(s) or other holder may hold readable identification information, numbers, medical information, financial or credit card information or other information, advertising, or other indicia. In FIG. 34, the chip is generally centered on one outer surface of the device, but one or more chips could instead be positioned on other areas or surfaces, as long as the chip is easily readable by swiping the chip-containing area against a reader or other sensor, or by getting close enough to a proximity sensor. In addition, other information or indicia may be printed on, or embossed into, the surface of the device or a card/layer of the device. The chip may or may not be visible to a viewer, but there may be indicia that shows the user the area containing the chip(s).

Alternatively, card(s), chip(s) and/or other information- or instruction-containing devices may be connected or attached to the grasping device in other ways, such as by a sleeve, flap, tether, magnetic connection, adhesive connection, snap-on connection, snap-in connection, and/or by other mechanisms/systems. A transparent or translucent flexible sleeve may contain card(s) or semiconductor ship(s) and be flexibly connected to the device. Such a sleeve may lie flat against one of the two plates, during normal use of the device, and then swing out or slide out from the device for ID checks and/or other uses of the card/chip.

Although this invention has been described above with reference to particular means, materials and embodiments, it is to be understood that the invention is not limited to these disclosed particulars, but extends instead to all equivalents within the broad scope of the following claims.

1. A grasper tool, for a hand comprising a thumb and a finger of a user, comprising:
two plates, each plate having a proximal end and a distal end, and each plate being connected at its proximal end to the other plate by a hinge;
the hinge being biased so that the distal end of each plate is urged to be separated from the distal end of the other plate; and
each plate being adapted to cooperate with the thumb or a finger of the hand of a user.

2. The grasper tool of claim 1, comprising also a latch component near the distal end of one of the plates.

3. The grasper tool of claim 1, wherein at least one of said plates has an inside surface comprising a pad, and the pad is selectively removable from the plate.

4. The grasper tool of claim 1, wherein at least one of said plates has an inside surface comprising a pad, wherein the pad is selectively replaceable on said inside surface.

5. The grasper tool of claim 1, wherein each plate is of a material, and each plate has an inside surface comprising a pad, said pad being of a different material than the material of the plate.

6. The grasper tool of claim 5, wherein the pad material has a greater coefficient of friction than the material of the plate.

7. The grasper tool of claim 5, wherein the pad material is softer than the material of the plate.

8. The grasper tool of claim 1 wherein at least one of said plates has an inside surface comprising a pad, and the pad comprises an anti-microbial agent.

9. The grasper tool of claim 3, wherein the removable pad comprises a plurality of thin sheets.

10. The grasper tool of claim 4, wherein the replaceable pad comprises a plurality of thin sheets.

11. The grasper tool of claim 1, wherein the bias in the hinge is provided by a spring.

12. The grasper tool of claim 1, wherein the bias in the hinge is provided by the resilient memory in an easily-repeatably-foldable section of plastic which is the hinge.

13. The grasper tool of claim 1, wherein the bias in the hinge is provided by an elastic band secured to both of the plates.

14. The grasper tool of claim 13, wherein the elastic band is secured to the outside of at least one of said plates.

15. The grasper tool of claim 13, wherein the elastic band is secured to the distal end of at least one of said plates, and extends through a space within said at least one plate.

16. The grasper tool of claim 1, wherein at least one of said plates has an outside surface, and wherein an information holder device that may be read by a digital reader is secured to the outside surface.

17. The grasper tool of claim 1, wherein at least one of said plates has an outside surface, and wherein an information holder device that may be read by a digital reader is secured to the outside surface.

18. The grasper tool of claim 1, wherein at least one of said plates has an outside surface, and wherein a sleeve is connected to said outside surface and has at least one open edge, for receiving an i.d. card, credit card, or other removable sheet through the at least one open edge and into the sleeve.

19. The grasper tool of claim 18, wherein said sleeve is opaque.

20. The grasper tool of claim 18, wherein said sleeve is transparent.
